(19) United States
(12) Patent Application Publication
(10) Pub. No.: US 2013/0251868 A1
(43) Pub. Date: Sep. 26, 2013

(54) Method and apparatus for beverage production and dispensing

(71) Applicant: IBS INTERBEV, INC., Longwood, FL (US)

(72) Inventor: John E. Wells, Oviedo, FL (US)

(73) Assignee: IBS Interbev, Inc., Longwood, FL (US)

(21) Appl. No.: 13/815,970

(22) Filed: Mar. 19, 2013

Related U.S. Application Data
(60) Provisional application No. 61/685,542, filed on Mar. 20, 2012.

(51) Int. Cl. A47J 31/46; A23F 3/18

(52) U.S. Cl. CPC A47J 31/46; A23F 3/18
USPC 426/435; 99/300

(57) ABSTRACT

A beverage concentrate system (10) includes a brewer (12), a receptacle (14), a heat exchanger (16) and pump (22). Beverage concentrate is pumped by pump (22) from the receptacle (14) and through the heat exchanger (16). The beverage concentrate is cooled in the heat exchanger (16) with water. The coolant water and the beverage concentrate are dispensed to form a finished beverage.

### CROSS-REFERENCE TO RELATED APPLICATION AND PRIORITY INFORMATION

This application claims the benefit of co-pending, prior filed U.S. provisional application no. 61/685,542, entitled “Method and Apparatus for Beverage Production and Dispensing”, filed Mar. 20, 2012.

### TECHNICAL FIELD OF THE INVENTION

This invention relates generally to beverage technology, and more particularly to methods and apparatus for the production and dispensing of tea beverages and other beverages.

### BACKGROUND OF THE INVENTION

Tea beverages are most often produced either by brewing the tea in ready to drink proportions, or by mixing a tea concentrate with water.

For tea beverages made from tea concentrates, two processes are generally used. In one process, the concentrate is produced at one facility and shipped to another (such as a restaurant or convenience store) for diluting with water and dispensing at finished-beverage strength.

In the second process, tea concentrate is produced locally at the dispensing site, and diluted with water (to form finished-beverage strength tea) either at the time of brewing, or shortly thereafter, for example in a tea urn. In these locally-produced-concentrate processes, the diluent water is mixed with the concentrate before the time of dispensing, and the finished-beverage strength tea is held in a container for dispensing.

Each of these concentrate processes has several drawbacks. For example, the first suffers from lack of freshness and high shipping costs, among others. The second suffers from a short shelf life (due to souring from mixing with cold water or otherwise non-aseptic handling) and from low output capacity, among others. Also, brewing at ready to drink proportions suffers from similar problems to those of existing locally-produced-concentrate processes, among others.

Therefore, a need has arisen for an improved tea beverage production system and method for production of tea beverages, and which also may be used to produce other beverages, such as, without limitation, coffee beverages.

### SUMMARY OF THE INVENTION

In accordance with the teachings of the present invention, methods and apparatus for the production of tea beverages and other beverages are provided which eliminate or substantially reduce problems associated with prior art systems.

In a particular embodiment, a beverage production system, located at a single facility, is provided that includes a brewer operable to brew a beverage concentrate, a water source, a heat exchanger receiving brewed concentrate from the brewer and water from the water source. The water cools the brewed concentrate in the heat exchanger, a pump pumps the beverage concentrate and water through the heat exchanger, and a dispensing valve dispenses the beverage concentrate and water that has been pumped through the heat exchanger for mixing to form a finished beverage.

### BRIEF DESCRIPTION OF THE DRAWINGS

Reference is made in the description to the following briefly described drawings, wherein like reference numerals refer to corresponding elements:

FIG. 1 is a schematic diagram of a beverage production and dispensing system according to one aspect of the teachings of the present invention; and

FIG. 2 is a schematic diagram of a beverage production and dispensing system according to one aspect of the teachings of the present invention.

### DETAILED DESCRIPTION OF THE INVENTION

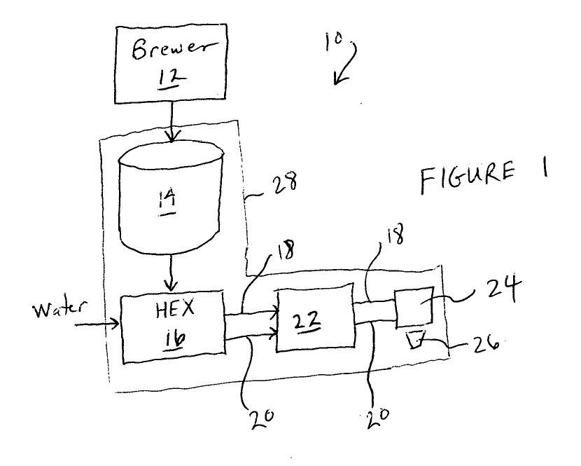

FIG. 1 is a block diagram of a beverage production system 10 according to one aspect of the teachings of the present invention. As shown, system 10 includes a brewer 12 that brews beverage concentrate. In a preferred embodiment, the beverage concentrate is a tea concentrate. However, other concentrates, such as, without limitation, coffee concentrates, may also be brewed. The system 10 (and the corresponding method of production) is located (or performed) at a single facility (such as, without limitation, a restaurant or convenience store).

The brewed concentrate is brewed into a receptacle 14, which is preferably insulated. Prior to dispensing, concentrate from the receptacle 14 flows through a heat exchanger 16. Heat exchanger 16 may be any suitable heat exchanger. Brewed concentrate flows in one or more conduits or chambers through the heat exchanger 16, and is cooled with the aid of a coolant flowing through the heat exchanger 16 (coolant flow is separate from the brewed concentrate flow). In a preferred embodiment, the coolant is water that will, at the time of dispensing, be mixed with the brewed concentrate to form a finished, single-strength, beverage. As shown in FIG. 1, water line 18 and cooled brewed concentrate line 20 exit heat exchanger 16. Water line 18 contains the coolant water that flowed through the heat exchanger 16 to cool the brewed concentrate. Cooled brewed concentrate line 20 contains cooled brewed concentrate.

These lines 18 and 20 are coupled to inlets of a pump 22. Pump 22 pumps the water and concentrate from lines 18 and 20 to a dispensing valve 24, which is generally activated by a user. Pump 22 may be any suitable pump for pumping the water and concentrate through the system 10, and preferably a ratio pump. One particular ratio is 4 parts concentrate to 1 part water. However, this example is without limitation, and any suitable concentration may be used.

Upon activation of the dispensing valve 24, the water and brewed concentrate are mixed to form the finished beverage. The valve 24 may be any suitable beverage valve used for dispensing water and concentrate. Although the singular term “valve” is used, it includes both single and multi-valve (such as one valve for water and one for concentrate) systems. Typically, mixing occurs in or outside a nozzle 26 that receives the water and concentrate from the valve 24.

In a preferred embodiment, the receptacle 14, heat exchanger 16, pump 22, and dispensing valve and nozzle 24 and 26 are contained in or coupled to a housing (or base) 28, so that the system 10 is a self-contained unit. The brewer 12 may be part of the housing 28, or separate.

Also, receptacle 14 may be detachably coupled to housing 28 and heat exchanger 16. Thus, for example, brewing (from brewer 12 into receptacle 14) may take place remotely from the housing 28. After such remote brewing, receptacle 14 (containing brewed concentrate) may be moved from the remote brewing location to the housing 28 and set in place for coupling with heat exchanger 16. Alternatively, remote brewing into another container may be used, and the brewed concentrate in that container may be poured or otherwise transferred into receptacle 14. Also, brewing may be local to housing 28, with brewing directly into receptacle 14 as it is in place on housing 14.

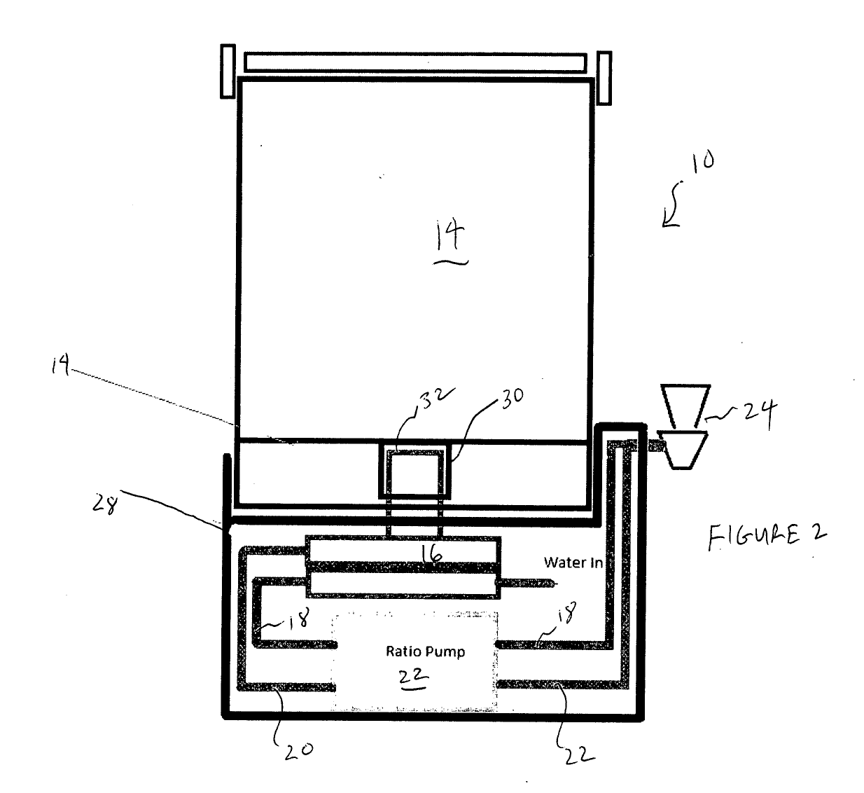

As shown in FIG. 2, receptacle 14 includes a receiver 30 for receiving a disconnect 32 of base (housing) 28. Receiver 30 and disconnect 32 allow coupling and decoupling of receptacle 14 to heat exchanger 16.

In a preferred embodiment, the housing 28 is sized for placement on the counter of a store or restaurant.

In a preferred embodiment, the beverage concentrate is brewed at a temperature of at least about 180° Fahrenheit. Brewing at this temperature kills most biological contaminants, thus allowing the beverage concentrate, if handled properly, to enjoy a relatively long shelf life. However, this example is without limitation, and any suitable brewing temperature may be used.

Receptacle 14 is preferably an insulated container, although it need not be. Also, it is preferred that the receptacle 14 may be hermetically sealed, although it need not be. Hermetic sealing lengthens the shelf life of the beverage concentrate. As an example of sealing, the receptacle 14 may be sealed after receiving the brewed beverage concentrate, without limitation, by latching closed a hermetically sealing cover to the receptacle 14. In another embodiment, the receptacle 14 may be coupled to the brewer as part of a closed brewing system in which brewed beverage concentrate flows into the receptacle through a passageway that is closed to the open environment.

Within this description, coupling includes both direct coupling of elements, and coupling indirectly through intermediate elements. Also, although brewing is the preferred method of producing the beverage concentrate, it may be produced in any conventional way, including, without limitation, steeping, with hot or cold water.

The particular embodiments and descriptions provided herein are illustrative examples only, and features and advantages of each example may be interchanged with, or added to the features and advantages in the other embodiments and examples herein. Moreover, as examples, they are meant to be without limitation as to other possible embodiments, are not meant to limit the scope of the present invention to any particular described detail, and the scope of the invention is meant to be broader than any example. Also, the present invention has several aspects, as described above, and they may stand alone, or be combined with some or all of the other aspects.

And, in general, although the present invention has been described in detail, it should be understood that various changes, alterations, substitutions, additions and modifications can be made without departing from the intended scope of the invention, as defined in the following claims.

What is claimed is:

1. A tea production system, comprising:
a brewer operable to brew a tea concentrate;
a water source;
a heat exchanger receiving the tea concentrate from the brewer and water from the water source, wherein the water cools the tea concentrate in the heat exchanger;
a dispensing valve receiving the tea concentrate and water from the heat exchanger, the dispensing valve operable to dispense the tea concentrate and water from the heat exchanger to form a finished beverage; and
wherein the brewer, water source, heat exchanger, and dispensing valve are located at a single facility.

2. A tea production system, comprising:
a brewer operable to brew a tea concentrate at a brewing temperature above ambient temperature;
a water source;
a heat exchanger receiving the tea concentrate from the brewer and water from the water source, wherein the water cools the tea concentrate in the heat exchanger by removing at least some heat imparted to the tea concentrate at the brewer;
a dispensing valve receiving the tea concentrate and water from the heat exchanger, the dispensing valve operable to dispense the tea concentrate and water from the heat exchanger to form a finished beverage; and
wherein the brewer, water source, heat exchanger, and dispensing valve are located at a single facility.

3. A method of producing a beverage, comprising:
brewing a beverage concentrate at a brewing temperature above ambient temperature;
cooling the beverage concentrate by transferring to water at least some heat imparted to the beverage concentrate during brewing;
dispensing the beverage concentrate and the water to form a finished beverage; and
wherein the brewing, cooling, and dispensing occur at a single facility.
